(19) United States
(12) Patent Application Publication
(10) Pub. No.: US 2022/0036674 A1
(43) Pub. Date: Feb. 3, 2022

(54) CONTROL SYSTEM

(71) Applicant: Panasonic Intellectual Property Management Co., Ltd., Osaka (JP)

(72) Inventors: Kumi HARADA, Osaka (JP); Makoto HIROKI, Osaka (JP); Keiichi TANAKA, Osaka (JP)

(21) Appl. No.: 17/278,702

(22) PCT Filed: Sep. 18, 2019
(86) PCT No.: PCT/JP2019/036652

§ 371 Date: Mar. 23, 2021

(30) Foreign Application Priority Data
Oct. 2, 2018 (JP) 2018-187667

(51) Int. Cl. G07C 9/00; H04W 4/021

(52) U.S. Cl. CPC G07C 9/00698; H04W 4/021

(57) ABSTRACT

A control system includes a communication unit capable of communicating with a mobile terminal and a device disposed inside a predetermined area, a setting unit that sets, to an enabled state or a disabled state, a first notification function of notifying the mobile terminal of a state of the device using the communication unit, and a control unit that performs a predetermined control using the communication unit when the first notification function is set to the disabled state and the mobile terminal is determined to have moved from the inside of the predetermined area to the outside of the predetermined area.

### TECHNICAL FIELD

The present invention relates to control systems.

### BACKGROUND ART

In recent years, home energy management systems (HEMSs) have increasingly been introduced into houses. A HEMS can “visualize” the amounts of energy used in a house, such as electricity and gas, by displaying the amounts on a monitor. A HEMS also enables controlling home appliances in a house. Patent literature 1 discloses a technique that enables remotely operating information devices using a HEMS.

### CITATION LIST

### Patent Literature

[PTL 1] Japanese Unexamined Patent Application Publication No. 2014-203411

### SUMMARY OF INVENTION

### Technical Problem

The present invention provides a control system capable of performing control for preventing accidents resulting from the state of a device when a user cannot directly operate the device.

### Solution to Problem

A control system according to an aspect of the present invention includes: a communication unit capable of communicating with a mobile terminal and a device disposed inside a predetermined area; a setting unit configured to set, to an enabled state or a disabled state, a first notification function of notifying the mobile terminal of a state of the device using the communication unit; and a control unit configured to perform a predetermined control when the first notification function is set to the disabled state and the mobile terminal is determined to have moved from the inside of the predetermined area to outside of the predetermined area.

A program according to an aspect of the present invention is a program that causes a computer to execute: setting, to an enabled state or a disabled state, a first notification function of notifying a mobile terminal of a state of a device by performing communication; and performing a predetermined control when the first notification function is set to the disabled state and the mobile terminal is determined to have moved from inside the predetermined area to outside of the predetermined area.

### Advantageous Effects of Invention

A control system according to an aspect of the present invention is capable of performing control for preventing accidents resulting from the state of a device when a user cannot directly operate the device.

### BRIEF DESCRIPTION OF DRAWINGS

FIG. 1 is a block diagram illustrating a functional configuration of a control system according to an embodiment.

FIG. 2 is a diagram illustrating an exemplary notification screen based on a first notification function.

FIG. 3 is a sequence diagram illustrating Operation Example 1 of the control system according to the embodiment.

FIG. 4 is a diagram illustrating an exemplary setting screen for the first notification function and a second notification function.

FIG. 5 is a diagram illustrating an exemplary setting screen for setting a predetermined area.

FIG. 6 is a flowchart illustrating the process of transmitting current position information.

FIG. 7 is a diagram illustrating an exemplary notification screen indicating that the first notification function remains disabled.

FIG. 8 is a sequence diagram illustrating Operation Example 2 of the control system according to the embodiment.

FIG. 9 is a diagram illustrating an exemplary notification screen indicating that an electric lock is closed.

FIG. 10 is a sequence diagram illustrating Operation Example 3 of the control system according to the embodiment.

### DESCRIPTION OF EMBODIMENTS

Hereinafter, embodiments will be described in detail with reference to the Drawings. It should be noted that each of the following embodiments shows a generic or specific example. The numerical values, shapes, materials, structural components, the arrangement and connection of the structural components, steps, the processing order of the steps, etc., shown in the following embodiments are mere examples, and thus are not intended to limit the present invention. Among the structural components described in the following embodiments, structural components not recited in any one of the independent claims will be described as optional structural components.

It should be noted that the respective figures are schematic diagrams and are not necessarily precise illustrations. Furthermore, in the figures, components that are substantially the same are given the same reference sign, and overlapping description may be omitted or simplified.

### Embodiment

### [Configuration]

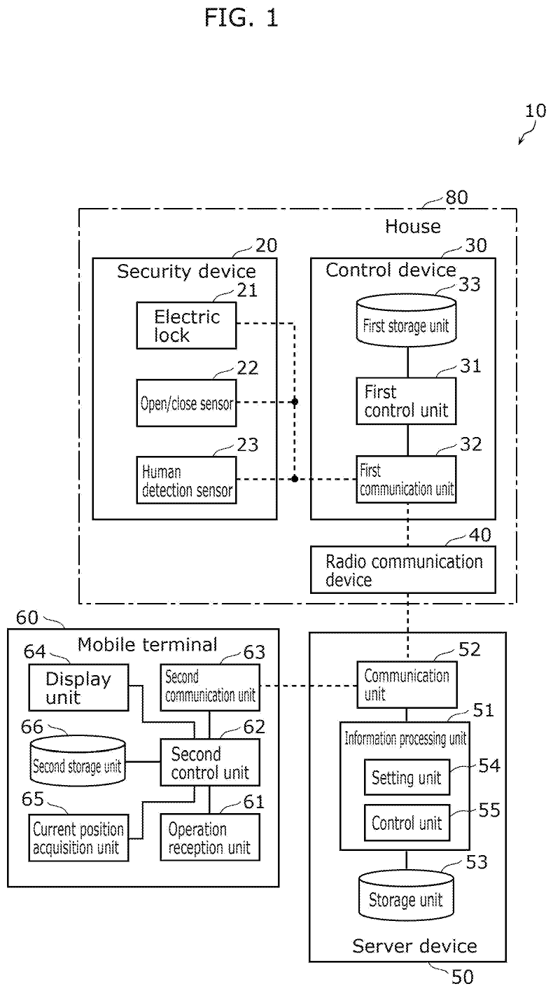

First, the configuration of a control system according to an embodiment will be described. FIG. 1 is a block diagram illustrating a functional configuration of the control system according to the embodiment.

Control system 10 according to the embodiment can monitor the states of security devices 20, such as electric lock 21 and open/close sensor 22, installed in a building such as house 80, and can provide notifications related to the states of security devices 20. Control system 10 includes security devices 20, control device 30, radio communication device 40, server device 50, and mobile terminal 60. It is to be noted that control system 10 may include at least one security device 20.

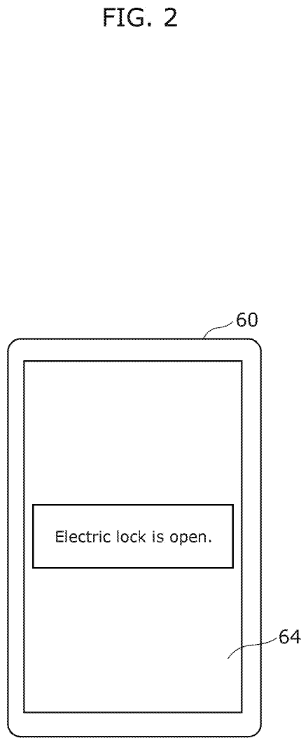

Control system 10 has a first notification function for notifying mobile terminal 60 owned by a user living in house 80 of the states of security devices 20. More specifically, the first notification function is a function of notifying mobile terminal 60 that electric lock 21 is open, or open/close sensor 22 has detected the open state (i.e., open/close sensor 22 has detected that a window or a door is open). FIG. 2 is a diagram illustrating an exemplary notification screen based on the first notification function. This screen is provided as a push notification, for example.

The first notification function prevents the user from forgetting to close electric lock 21 before going out, or from forgetting to close a window or a door before going out. That is, the first notification function prevents accidents, such as theft, resulting from the lock state of electric lock 21 and the state of open/close sensor 22.

Now, if the first notification function is enabled when the user is in house 80, the user may be bothered by a notification provided every time electric lock 21 is opened (or a window or a door is opened). To address this, control system 10 can set the first notification function to the enabled state or the disabled state according to the user's operation on mobile terminal 60. The user can enable the first notification function only when going out, thereby avoiding unnecessary notifications.

A problem with the first notification function, which is expected to be frequently enabled and disabled as above, is how to prevent the user from forgetting to enable the first notification function when going out. Control system 10 therefore has a second notification function for notifying the user, if the user goes out with the first notification function disabled, that the first notification function remains disabled. The configurations of the devices in control system 10 above will be described in detail below.

### [Security Devices]

First, security devices 20 will be described. Security devices 20 can be monitored by control device 30. For example, security devices 20 include electric lock 21, open/close sensor 22, and human detection sensor 23.

Electric lock 21 is a lock device that is electrically opened and closed. For example, electric lock 21 is a cylinder lock for locking and unlocking the main entrance door or a back door of house 80. Electric lock 21 may also be a crescent lock for locking and unlocking a window. Electric lock 21 may be opened (or closed) in any manner, for example, mechanical key-based, card-based, biometric, or password number-based manner.

Open/close sensor 22 detects opening and closing of a window in house 80. For example, the open/close sensor is attached to one of the window and the window frame, and detects the open/closed state of the window based on the magnetic force of a magnet attached to the other one of the window and the window frame. Open/close sensor 22 may also detect the open/closed state of a door of house 80.

Human detection sensor 23 is installed on the premises of house 80 (inside or outside house 80) and detects the presence of a human. Human detection sensor 23 is a pyroelectric infrared detector that detects infrared rays (in other words, heat waves) radiated from a human body, for example, but may be a thermal imagery sensor. Human detection sensor 23 is not limited to an infrared detection sensor but may be a sensor that relies on ultrasound to detect the presence of a human. The above-described first notification function may be a function of notifying mobile terminal 60 that human detection sensor 23 has detected a human (for example, an intruder into house 80).

Although not shown, each security device 20 has a communication circuit (in other words, a communication module) for wireless communication with control device 30. Security device 20 transmits a state notification signal to control device 30 for notification of the state of security device 20. Electric lock 21 may be opened or closed in response to a control signal received from control device 30.

### [Control Device and Radio Communication Device]

Control device 30, which is, for example, a HEMS controller, is provided in house 80 and monitors the states of security devices 20 installed in house 80 (or on the premises of house 80). Control device 30 can also control electric lock 21 to be opened or closed. Control device 30 is not limited to a HEMS controller having an energy management function but may be other types of home controllers or gateway devices without energy management function. Control device 30 includes first control unit 31, first communication unit 32, and first storage unit 33.

First control unit 31 performs control related to control device 30. First control unit 31 is implemented by a microcomputer, for example, but may be implemented by a processor or a dedicated circuit.

First communication unit 32 is a communication circuit for control device 30 to communicate with security devices 20 and radio communication device 40. First communication unit 32 wirelessly communicates with security devices 20, although first communication unit 32 may perform wired communication with security devices 20. First communication unit 32 wirelessly communicates with radio communication device 40. First communication unit 32 may communicate according to any communication standard. Communication between first communication unit 32 and security devices 20 conforms to ECHONET Lite®, for example.

First storage unit 33 is a storage device in which items such as control programs executed by first control unit 31 are stored. First storage unit 33 is implemented by semiconductor memory, for example.

Radio communication device 40 is a wireless local area network (LAN) router provided in house 80. Control device 30 is communicatively connected to radio communication device 40. Control device 30 and server device 50 communicate with each other via radio communication device 40.

When mobile terminal 60 enters the communicable range (coverage) of radio communication device 40, mobile terminal 60 is communicatively connected to radio communication device 40. Mobile terminal 60 inside the coverage of radio communication device 40 communicates with server device 50 via radio communication device 40. Mobile terminal 60 outside the coverage of radio communication device 40 communicates with server device 50 via a mobile communication network rather than radio communication device 40.

### [Server Device]

Server device 50 performs various sorts of information processing related to the second notification function. Server device 50 is provided by the manufacturer of control device 30, for example. Server device 50 includes information processing unit 51, communication unit 52, and storage unit 53.

Information processing unit 51 performs information processing related to the second notification function. Information processing unit 51 includes setting unit 54 and control unit 55. Information processing unit 51 is implemented by a microcomputer, for example, but may be implemented by a processor or a dedicated circuit.

Communication unit 52 is a communication circuit for server device 50 to communicate with radio communication device 40 and mobile terminal 60. Communication unit 52 can also communicate with security devices 20 via radio communication device 40 and control device 30. That is, communication unit 52 can communicate with mobile terminal 60 and security devices 20. Communication unit 52 may communicate according to any communication standard.

Storage unit 53 is a storage device in which items such as control programs executed by information processing unit 51 are stored. Storage unit 53 is implemented by semiconductor memory, for example.

### [Mobile Terminal]

Mobile terminal 60 is a mobile information terminal, such as a smartphone or a tablet terminal, owned by the user. Mobile terminal 60 includes operation reception unit 61, second control unit 62, second communication unit 63, display unit 64, current position acquisition unit 65, and second storage unit 66.

Operation reception unit 61 receives the user's operations. Operation reception unit 61 is implemented by a touch panel or hardware buttons, for example.

Second control unit 62 performs various sorts of information processing based on, e.g., operations received by operation reception unit 61. Second control unit 62 is implemented by a microcomputer, for example, but may be implemented by a processor or a dedicated circuit.

Second communication unit 63 is a communication circuit for mobile terminal 60 to communicate with radio communication device 40 and server device 50. For example, second communication unit 63 performs short-range wireless communication with radio communication device 40, and performs wireless communication with server device 50 over a mobile communication network. Second communication unit 63 may communicate according to any communication standard.

Display unit 64 presents a display screen under the control of second control unit 62. Specifically, display unit 64 is a display that includes, as a display device, a liquid crystal panel or an organic electroluminescence (EL) panel.

Current position acquisition unit 65 acquires (in other words, computes) the current position of mobile terminal 60 and outputs, to second control unit 62, current position information indicating the current position acquired. Current position acquisition unit 65 is implemented by a global positioning system (GPS) module, for example.

Second storage unit 66 is a storage device in which items such as control programs executed by second control unit 62 are stored. Second storage unit 66 is implemented by semiconductor memory, for example.

### Operation Example 1

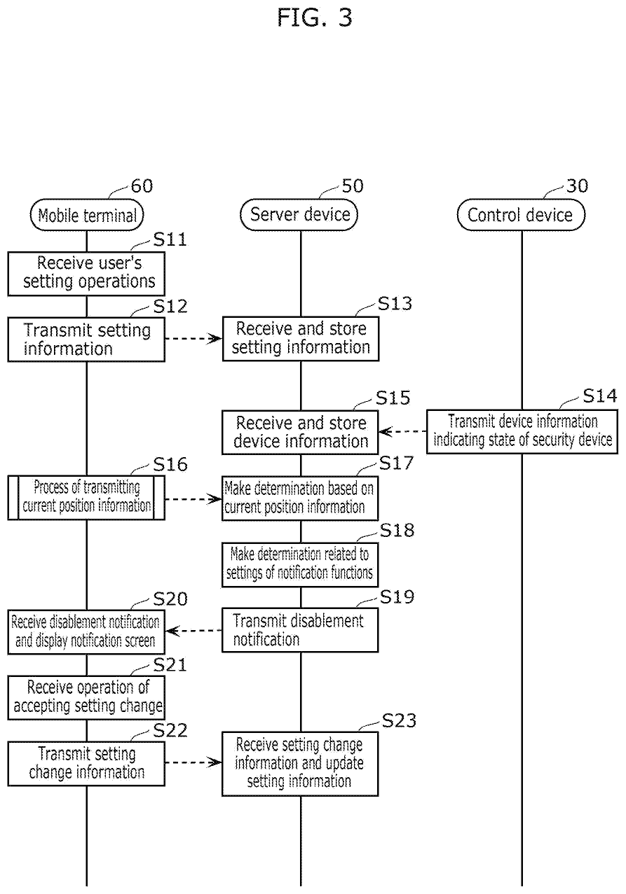

Now, Operation Example 1 of control system 10 will be described. FIG. 3 is a sequence diagram illustrating Operation Example 1 of control system 10.

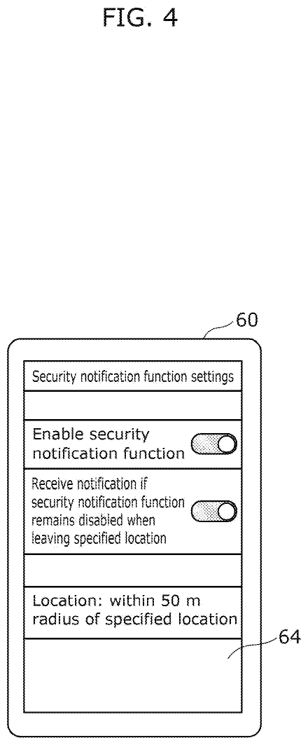

First, operation reception unit 61 of mobile terminal 60 receives the user's setting operations for enabling or disabling the first notification function and enabling or disabling the second notification function (S11). At step S11, a setting screen as shown in FIG. 4 is displayed on display unit 64 of mobile terminal 60. FIG. 4 is a diagram illustrating an exemplary setting screen for the first notification function and the second notification function.

On the setting screen shown in FIG. 4, the user can specify whether to enable the first notification function (expressed as the security notification function in the figure) and whether to enable the second notification function (whether to receive a notification if the security notification function remains disabled when the user leaves a specified location).

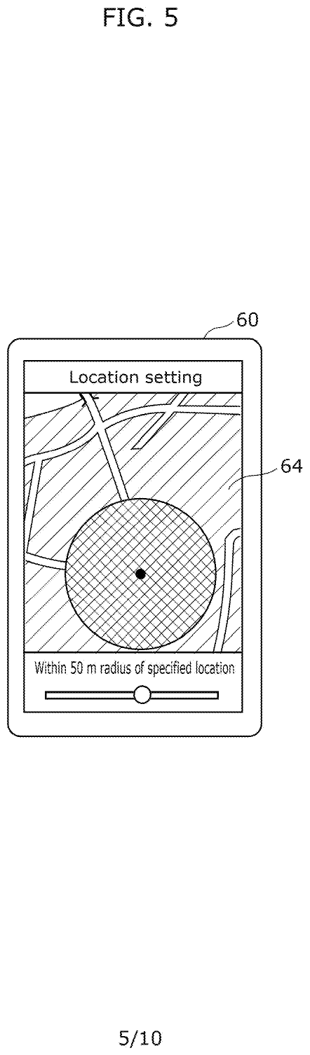

The user also sets a predetermined area through the setting screen in FIG. 4. The predetermined area is a parameter for determining whether the user has gone out. How the predetermined area is used will be described below. To set the predetermined area, the setting screen in FIG. 4 transitions to another screen. FIG. 5 is a diagram illustrating an exemplary setting screen for setting the predetermined area. As shown in FIG. 5, in response to the user selecting a position on the map, a round area centered at the position selected is set as the predetermined area. For example, the user may set a round area centered at house 80. Security devices 20 installed in house 80 are then regarded as being within the predetermined area. Setting information indicating the predetermined area is stored by second control unit 62 in second storage unit 66 of mobile terminal 60.

Second control unit 62 then causes second communication unit 63 to transmit setting information indicating the settings made at step S11 (S12). The setting information transmitted by second communication unit 63 is received by communication unit 52 of server device 50 and stored by setting unit 54 in storage unit 53 (S13). That is, setting unit 54 sets the first notification function to the enabled state or the disabled state, and sets the second notification function to the enabled state or the disabled state. The setting information stored in storage unit 53 need not include the setting information about the predetermined area.

Meanwhile, first communication unit 32 of control device 30 transmits, under the control of first control unit 31, security device information indicating the state of each security device 20 (S14). The security device information transmitted is received by communication unit 52 of server device 50 and stored by information processing unit 51 in storage unit 53 (S15). It is to be noted that the point at which the security device information is transmitted is not limited to the point shown in FIG. 3. Control device 30 may transmit the security device information upon every change in the state of each security device 20, or at predetermined time intervals, or in response to a request from server device 50. In any case, the security device information in storage unit 53 of server device 50 is accordingly updated.

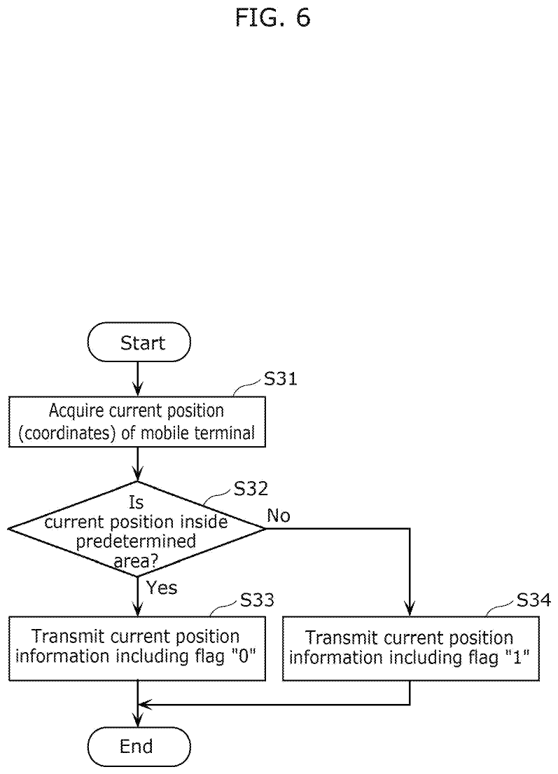

Second control unit 62 of mobile terminal 60 then performs the process of transmitting current position information (S16). FIG. 6 is a flowchart illustrating the process of transmitting the current position information.

First, current position acquisition unit 65 acquires the current position (i.e., the coordinates) of mobile terminal 60 (S31). Second control unit 62 then determines whether the current position of mobile terminal 60 is inside the predetermined area (S32). If the current position is determined to be inside the predetermined area (Yes at S32), second control unit 62 causes second communication unit 63 to transmit current position information that includes a flag set to “0” (S33). If the current position is determined to be outside the predetermined area (No at S32), second control unit 62 causes second communication unit 63 to transmit the current position information that includes the flag set to “1” (S34). The current position information is transmitted at predetermined intervals of some seconds, for example. The logic of the flag may be reversed.

In this manner, the current position information transmitted includes the flag indicating whether the current position of mobile terminal 60 is inside the predetermined area, but does not include the coordinates of the current position of mobile terminal 60. This can protect the user's privacy because the coordinates of the user's current position are not transmitted to server device 50.

The determination at step S32 need not be made by mobile terminal 60. Rather, mobile terminal 60 may transmit the coordinates of the current position of mobile terminal 60 as the current position information to server device 50, which may receive this information and make a determination as in step S32.

Communication unit 52 of server device 50 receives the current position information above, and control unit 55 makes a determination based on the current position information received (S17). Control unit 55 determines, based on the flag in the current position information, whether mobile terminal 60 has moved from inside the predetermined area to outside the predetermined area. That is, control unit 55 determines whether mobile terminal 60 has moved a predetermined distance or farther away from house 80.

If control unit 55 determines that mobile terminal 60 has moved from inside the predetermined area to outside the predetermined area based on the flag in the current position information (i.e., if the flag is determined to have changed from 0 to 1), control unit 55 makes a determination related to the settings of the first notification function and the second notification function (S18). Control unit 55 refers to the setting information stored in storage unit 53 to determine whether the first notification function is disabled and the second notification function is enabled. If mobile terminal 60 is not determined to have moved from inside the predetermined area to outside the predetermined area, the processing at step S18 and the subsequent steps are not performed.

If control unit 55 determines that the first notification function is disabled and the second notification function is enabled, control unit 55 causes communication unit 52 to transmit a disablement notification indicating that the first notification function remains disabled (S19). The disablement notification is a notification based on the second notification function. If control unit 55 does not determine that the first notification function is disabled and the second notification function is enabled, the processing at step S19 and the subsequent steps are not performed.

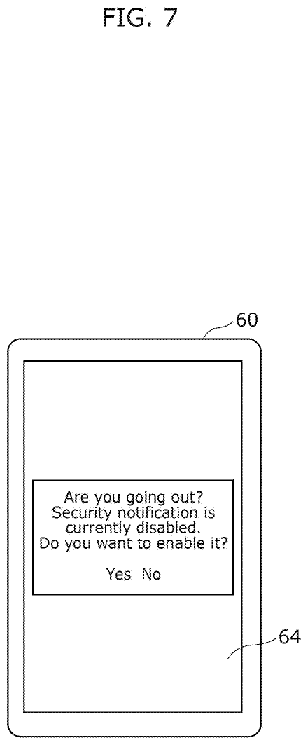

The disablement notification is received by second communication unit 63 of mobile terminal 60, and display unit 64 of mobile terminal 60 displays a notification screen; the notification screen indicates that the first notification function remains disabled, and prompts the user to accept a setting change for enabling the first notification function (S20). FIG. 7 is a diagram illustrating an exemplary notification screen indicating that the first notification function remains disabled and prompting the user to accept a setting change for enabling the first notification function. This notification screen is provided as a push notification, for example.

If operation reception unit 61 receives the user's operation of accepting the setting change while the notification screen in FIG. 7 is displayed (S21), second control unit 62 causes second communication unit 63 to transmit setting change information for enabling the first notification function (S22). The setting change information is received by communication unit 52 of server device 50, and setting unit 54 updates the setting information stored in storage unit 53 (S23). This update changes the setting of the first notification function from the disabled state to the enabled state.

Thereafter, if, for example, the security device information stored at step S15 above indicates that electric lock 21 is in the unlocked state, a notification is provided from server device 50 to mobile terminal 60. Display unit 64 of mobile terminal 60 displays the notification screen as shown in FIG. 2 above. A similar process is followed if the security device information indicates that open/close sensor 22 has detected the open state.

As described above, if the first notification function is determined to be set to the disabled state and mobile terminal 60 is determined to have moved from inside the predetermined area to outside the predetermined area, control system 10 performs the second notification function. The second notification function is a function of notifying mobile terminal 60, through communication unit 52, that the first notification function remains disabled.

Thus, if the user has presumably left house 80 with the first notification function disabled, control system 10 above can notify the user that the first notification function remains disabled. Because this prevents the user from forgetting to enable the first notification function of notifying the states of electric lock 21 and open/close sensor 22, the user is less likely to have accidents, such as theft, in house 80.

It is to be noted that the second notification function need not be able to be disabled but may be always enabled. It is also to be noted that the point at which the determination related to the notification functions at step S18 is made is not limited to the point shown in FIG. 3. For example, the determination related to the notification functions at step S18 may be made before step S15.

### Operation Example 2

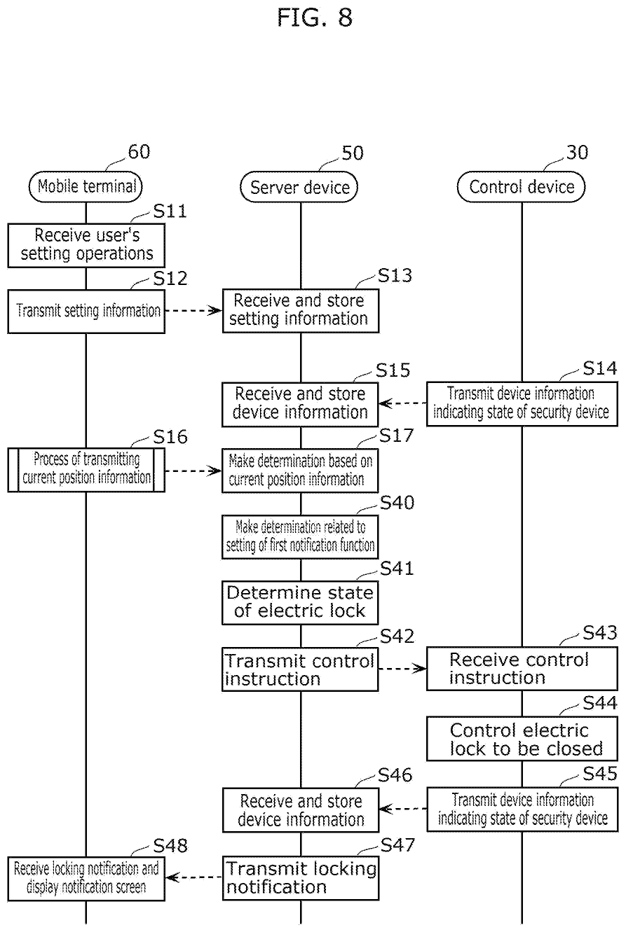

Control system 10 need not have the second function. Operation Example 2 of control system 10 in this case will be described below. FIG. 8 is a sequence diagram illustrating Operation Example 2 of control system 10. For Operation Example 2, the following will mainly describe points different from Operation Example 1 and not describe points already described.

In Operation Example 2, after the processing at steps S11 to S17 is performed as in Operation Example 1, the determination related to the first notification function is made (S40). If at step S17, mobile terminal 60 is determined to have moved from inside the predetermined area to outside the predetermined area, and if at step S40, the first notification function is determined to be disabled, control unit 55 refers to the security device information stored in storage unit 53 to determine the state of electric lock 21 (S41). If the first notification function is not determined to be disabled, the processing at step S41 and the subsequent steps are not performed.

If control unit 55 determines that electric lock 21 is in the unlocked state, control unit 55 performs first control for switching electric lock 21 from the unlocked state to the locked state. Specifically, control unit 55 causes communication unit 52 to transmit a control instruction (S42). If electric lock 21 is not determined to be in the unlocked state (i.e., determined to be in the locked state), the processing at step S42 and the subsequent steps are not performed.

The control instruction is received by first communication unit 32 (S43), and first control unit 31 of control device 30 controls electric lock 21 to be closed (S44). Specifically, first control unit 31 transmits a control signal to electric lock 21 to close electric lock 21. In this manner, control unit 55 of server device 50 performs the first control of switching electric lock 21 from the unlocked state to the locked state by transmitting the control instruction through communication unit 52.

First communication unit 32 of control device 30 then transmits, under the control of first control unit 31, security device information indicating the state of electric lock 21 (S45). The security device information transmitted is received by communication unit 52 of server device 50 and stored by information processing unit 51 in storage unit 53 (S46). That is, the state of electric lock 21 in the security device information stored in storage unit 53 is updated.

Once the state of electric lock 21 in the security device information is updated after the first control, control unit 55 performs second control of notifying that electric lock 21 has been switched from the unlocked state to the locked state. Specifically, control unit 55 causes communication unit 52 to transmit a locking notification (S47).

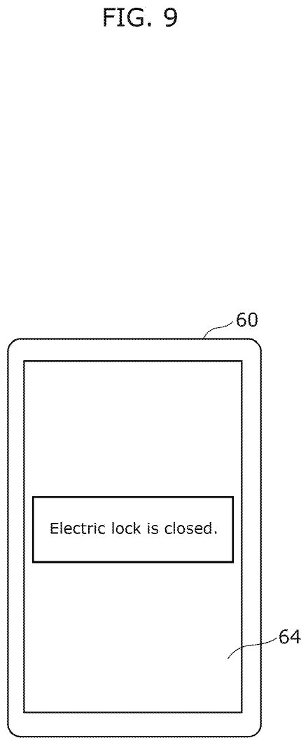

The locking notification is received by second communication unit 63 of mobile terminal 60, and display unit 64 of mobile terminal 60 displays a notification screen indicating that electric lock 21 is closed (S48). FIG. 9 is a diagram illustrating an exemplary notification screen indicating that electric lock 21 is closed. This notification screen is provided as a push notification, for example. In this manner, control unit 55 of server device 50 performs the second control of notifying that electric lock 21 has been switched from the unlocked state to the locked state by transmitting the locking notification through communication unit 52.

As described above, if first notification function is determined to be set to the disabled state and mobile terminal 60 is determined to have moved from inside the predetermined area to outside the predetermined area, control system 10 performs the first control of switching electric lock 21 from the unlocked state to the locked state. Because this prevents the user from going out with electric lock 21 open, the user is less likely to have accidents, such as theft, in house 80.

### Operation Example 3

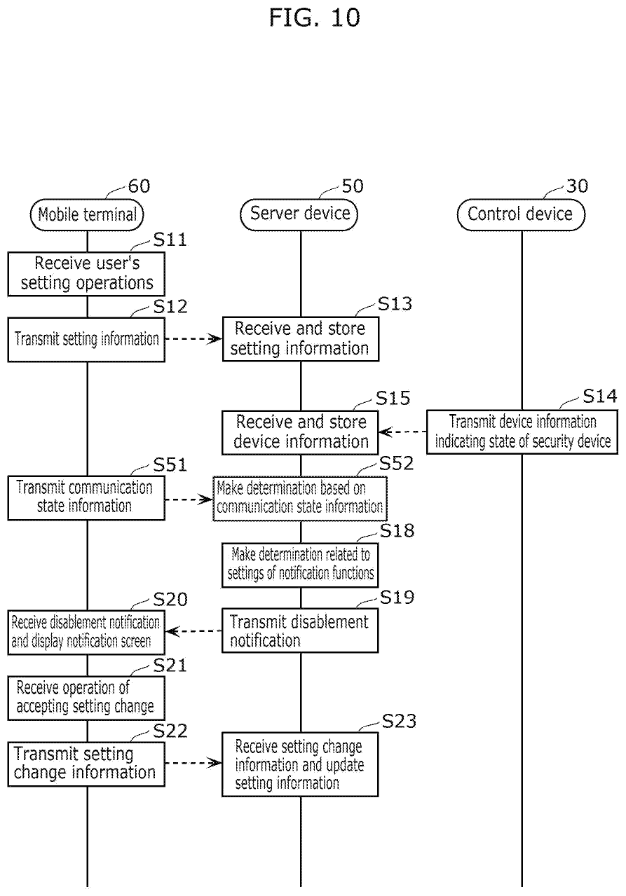

The determination of the movement of mobile terminal 60 from inside the predetermined area to outside the predetermined area is not limited to the manner based on the current position information on mobile terminal 60. For example, second communication unit 63 of mobile terminal 60 may have a function of, upon entering the coverage of radio communication device 40 while wirelessly communicating over a mobile communication network, switching from the wireless communication to short-range wireless communication with radio communication device 40. This switching function may serve as the basis for the determination of the movement of mobile terminal 60 from inside the predetermined area to outside the predetermined area. FIG. 10 is a sequence diagram illustrating Operation Example 3 of control system 10 in this case. For Operation Example 3, the following will mainly describe points different from Operation Example 1 and not describe points already described.

In Operation Example 3, after the processing at steps S11 to S15, second control unit 62 of mobile terminal 60 transmits communication state information (551). The communication state information indicates whether second communication unit 63 is in wireless communication over the mobile communication network or in short-range wireless communication with radio communication device 40. If second communication unit 63 is determined to be in wireless communication over the mobile communication network, second control unit 62 causes second communication unit 63 to transmit the communication state information that include a flag set to “0”. If second communication unit 63 is determined to be in short-range wireless communication with radio communication device 40, second control unit 62 causes second communication unit 63 to transmit the communication state information that includes the flag set to “1”. The communication state information is transmitted at predetermined time intervals, for example, some seconds. The logic of the flag may be reversed.

Communication unit 52 of server device 50 receives the communication state information, and control unit 55 makes a determination based on the communication state information received (S52). Based on the flag in the communication state information, control unit 55 determines whether mobile terminal 60 has moved from inside the predetermined area (i.e., inside the coverage of radio communication device 40) to outside the predetermined area (i.e., outside the coverage of radio communication device 40). That is, control unit 55 determines whether mobile terminal 60 has moved a predetermined distance or farther away from the user's house.

If mobile terminal 60 is determined to have moved from inside the predetermined area to outside the predetermined area based on the flag in the communication state information, control unit 55 causes communication unit 52 to transmit a disablement notification (S19). The subsequent processing is similar to that in Operation Example 1. If mobile terminal 60 is not determined to have moved from inside the predetermined area to outside the predetermined area, the processing at step S19 and the subsequent steps are not performed.

As described above, in Operation Example 3, again, if the first notification function is determined to be set to the disabled state and mobile terminal 60 is determined to have moved from inside the predetermined area to outside the predetermined area, control system 10 performs the second notification function. Thus, if the user has presumably left house 80 with the first notification function disabled, control system 10 above can notify the user that the first notification function remains disabled. Because this prevents the user from forgetting to enable the first notification function of notifying the states of electric lock 21 and open/close sensor 22, the user is less likely to have accidents, such as theft, in house 80. The determination based on the communication state information in Operation Example 3 may be combined with Operation Example 2.

The determination whether the user has moved from inside the predetermined area to outside the predetermined area is not limited to the manner involving mobile terminal 60 as in Operation Examples 1 to 3. As described above, control device 30 is a HEMS controller managing the power consumption of home appliances on the premises of house 80. If the total power consumption in house 80 is relatively high, the user is presumably in house 80; if the total power consumption in house 80 is relatively low, the user is presumably out of house 80. As such, server device 50 may obtain power consumption information indicating the total power consumption in house 80 from control device 30. Based on the power consumption information obtained, server device 50 may determine whether the user is out of house 80 (i.e., whether the user has moved from inside the predetermined area to outside the predetermined area).

Alternatively, a pyroelectric infrared sensor (for example, human detection sensor 23) that detects infrared rays radiated from a human body may be provided in house 80. The detection by the pyroelectric infrared sensor may serve as the basis for determining whether the user has moved from inside the predetermined area (i.e., inside house 80) to outside the predetermined area (i.e., outside house 80).

### [Variation]

In Operation Examples 1 and 3 above, server device 50 transmits the disablement notification to mobile terminal 60, and, based on the reception of the user's acceptance operation, sets the first notification function to the enabled state. However, the processing related to transmitting the disablement notification and receiving the acceptance operation may be skipped. That is, the processing at steps S19 to S23 may be skipped. In this case, if at step S17, mobile terminal 60 is determined to have moved from inside the predetermined area to outside the predetermined area and if at step S18, the first notification function is determined to be set to the disabled state, control unit 55 may control setting unit 54 to set the first notification function to the enabled state.

Conversely, if the first notification function is determined to be set to the enabled state and mobile terminal 60 is determined to have moved from outside the predetermined area to inside the predetermined area, setting unit 54 may set the first notification function to the disabled state. In this case, as in Operation Examples 1 and 3, server device 50 may perform or skip the processing related to transmitting an enablement notification for notifying that the first notification function remains enabled, and the processing related to the reception of an acceptance operation.

Thus, the first notification function may be enabled or disabled according to the current position of mobile terminal 60. This prevents the user from forgetting to enable the first notification function when going out, and from forgetting to disable the first notification function when returning home.

### Advantageous Effects

As described above, control system 10 includes: communication unit 52 capable of communicating with mobile terminal 60 and a device disposed inside a predetermined area; setting unit 54 that sets, to an enabled state or a disabled state, a first notification function of notifying mobile terminal 60 of a state of the device using communication unit 52; and control unit 55 that performs a predetermined control when the first notification function is set to the disabled state and mobile terminal 60 is determined to have moved from the inside of the predetermined area to the outside of the predetermined area.

Control system 10 as above can perform, when the user of mobile terminal 60 leaves the location of the device with the first notification function disabled, control of notifying the user that the first notification function remains disabled. Control system 10 can also perform, when the user of mobile terminal 60 leaves the location of the device with the first notification function disabled, control of switching the device to a safer state. That is, control system 10 can perform control for preventing accidents resulting from the state of the device when the user cannot directly operate the device.

Furthermore, for example, the device is security device 20, and the first notification function is a function of notifying mobile terminal 60 of the state of security device 20.

Control system 10 as above can notify mobile terminal 60 of the state of security device 20.

Furthermore, for example, security device 20 is electric lock 21, and the first notification function is a function of notifying mobile terminal 60 of an unlocked state of electric lock 21.

Control system 10 as above can notify mobile terminal 60 of the unlocked state of electric lock 21.

Furthermore, for example, electric lock 21 is a crescent lock for unlocking and locking a window.

Control system 10 as above can notify mobile terminal 60 of the unlocked state of the crescent lock.

Furthermore, for example, security device 20 is open/close sensor 22 of a window or a door, and the first notification function is a function of notifying mobile terminal 60 of an open state detected by open/close sensor 22.

Control system 10 as above can notify mobile terminal 60 of the open state detected by open/close sensor 22.

Furthermore, in Operation Example 1, control unit 55 performs, using communication unit 52, a second notification function of notifying mobile terminal 60 that the first notification function is disabled, as the predetermined control.

Control system 10 as above can, when the user of mobile terminal 60 leaves the location of the device with the first notification function disabled, notify the user that the first notification function remains disabled.

Furthermore, for example, security device 20 is human detection sensor 23, and the first notification function is a function of notifying mobile terminal 60 that a person is detected by human detection sensor 23.

Control system 10 as above can notify mobile terminal 60 that a person is detected by human detection sensor 23.

Furthermore, for example, setting unit 54 is capable of setting the second notification to an enabled state or a disabled state.

This allows the user of mobile terminal 60 to enable or disable the second notification function.

Furthermore, in Operation Example 2, control unit 55 performs, as the predetermined control, a first control of switching electric lock 21 from an unlocked state to a locked state.

When the user of mobile terminal 60 leaves the location of the device with the first notification function disabled, control system 10 as above can switch electric lock 21 to a state that eliminates the need to enable the first notification function (i.e., the locked state).

Furthermore, in Operation Example 2, control unit 55 performs, in addition to the first control, a second control of notifying that electric lock 21 is switched from the unlocked state to the locked state.

Control system 10 as above can notify that electric lock 21 is switched from the unlocked state to the locked state.

Furthermore, in the variation, control unit 55 performs, as the predetermined control, a control of causing setting unit 54 to set the first notification function to the enabled state.

This prevents the user from forgetting to enable the first notification function when going out.

Furthermore, in the variation, setting unit 54 further sets the first notification function to the disabled state when the first notification function is set to the enabled state and mobile terminal 60 is determined to have moved from the outside of the predetermined area to the inside of the predetermined area.

This prevents the user from forgetting to disable the first notification function when returning home.

Furthermore, in Operation Examples 1 and 2, communication unit 52 receives current position information of mobile terminal 60 from mobile terminal 60. Control unit 55 determines whether mobile terminal 60 has moved from the inside of the predetermined area to the outside of the predetermined area, based on the current position information received by communication unit 52.

Control system 10 as above can determine, based on the current position information on mobile terminal 60, whether mobile terminal 60 has moved from inside the predetermined area to outside the predetermined area.

Furthermore, for example, the current position information indicates whether a current position is inside the predetermined area, and does not indicate coordinates of the current position.

Control system 10 as above can protect the privacy of the user of mobile terminal 60 because the coordinates of the current position of mobile terminal 60 are not transmitted from mobile terminal 60 to the outside.

Furthermore, in Operation Example 3, the device is installed in house 80, and the predetermined area is an area in which radio communication device 40 installed in house 80 is capable of radio communication. House 80 is an example of a building. C communication unit 52 receives, from mobile terminal 60, communication connection information indicating the state of communication connection between mobile terminal 60 and radio communication device 40. Control unit 55 determines whether mobile terminal 60 has moved from the inside of the predetermined area to the outside of the predetermined area based on the communication connection information received by communication unit 52.

Control system 10 as above can determine, based on the communication connection information indicating the state of communication connection between mobile terminal 60 and radio communication device 40, whether mobile terminal 60 has moved from inside the predetermined area to outside the predetermined area.

Furthermore, a program executed by a computer of control system 10, and so on, is a program that causes the computer to execute: setting, to an enabled state or a disabled state, a first notification function of notifying mobile terminal 60 of a state of a device by performing communication; and performing a predetermined control when the first notification function is set to the disabled state and mobile terminal 60 is determined to have moved from the inside of the predetermined area to the outside of the predetermined area.

The program as above can realize, when the user of mobile terminal 60 leaves the location of the device with the first notification function disabled, control of notifying the user that the first notification function remains disabled. Furthermore, the program can also realize, when the user of mobile terminal 60 leaves the location of the device with the first notification function disabled, control of switching the device to a safer state. Specifically, the program can realize control for preventing accidents resulting from the state of the device when the user cannot directly operate the device.

### Other Embodiments

Although an exemplary embodiment has been described above, the present invention is not limited to the foregoing embodiment.

For example, in the foregoing embodiment, a process executed by a particular processing unit may be executed by a different processing unit. For example, part or all processes performed by the server device may be performed by the control device.

Furthermore, there is no particular limitation on the method of communication between devices in the foregoing embodiment. Wireless communication may be performed or wired communication may be performed between devices. Furthermore, wireless communication and wired communication may be combined between the devices. Moreover, when two apparatuses communicate in the foregoing embodiment, a relay device not shown in the drawings may be present therebetween.

The order of processes described in the sequence diagrams and flowcharts of the foregoing embodiment are merely examples. The order of multiple processes may be changed, and multiple processes may be performed in parallel.

Furthermore, in the foregoing embodiment, each of the structural components may be implemented by executing a software program suited to that structural element. Each of the structural elements may be implemented by a program executing unit such as a CPU or a processor reading out a software program recorded on a recording medium such as a hard disk or a semiconductor memory and executing the software program.

Furthermore, each of the structural components may be implemented by hardware. For example, each of the structural components may be a circuit (or an integrated circuit). These circuits as a whole may compose a single circuit or may be individual circuits. Moreover, each of the structural components may be a general-purpose circuit or a dedicated circuit.

Furthermore, general or specific aspects of the present invention may be implemented as a system, an apparatus, a method, an integrated circuit, a computer program, or a computer-readable recording medium such as a CD-ROM. Furthermore, the general or specific aspects may be implemented as any combination of a system, an apparatus, a method, an integrated circuit, a computer program, and a recording medium.

For example, the present invention may be implemented as a control method executed by a computer of a control system, and the like, or may be implemented as program for causing a computer to execute such a control method. Furthermore, the present invention may be implemented as a non-transitory computer-readable recording medium on which such a program is recorded.

Furthermore, although the control system is implemented by a plurality of devices in the foregoing embodiment, the control system may be implemented as a single device. The control system may be implemented as a single device equivalent to, for example, the server device, or may be implemented as a single device equivalent to the control device. When the control system is to be implemented by a plurality of devices, the structural components included in the control system may be distributed among the plurality of devices in any manner.

Aside from the above, the present invention encompasses forms obtained by various modifications to the foregoing embodiments that may be conceived by those skilled in the art, as well as forms realized by arbitrarily combining structural components and functions in the respective embodiments without departing from the essence of the present invention.

### REFERENCE SIGNS LIST

10 control system
20 security device
21 electric lock
22 open/close sensor
23 human detection sensor
40 radio communication device
52 communication unit
54 setting unit
55 control unit
60 mobile terminal
80 house (building)

1. A control system, comprising:
a communication unit capable of communicating with a mobile terminal and a device disposed inside a predetermined area;
a setting unit configured to set, to an enabled state or a disabled state, a first notification function of notifying the mobile terminal of a state of the device using the communication unit; and
a control unit configured to perform a predetermined control when the first notification function is set to the disabled state and the mobile terminal is determined to have moved from the inside of the predetermined area to outside of the predetermined area.

2. The control system according to claim 1, wherein
the device is a security device, and
the first notification function is a function of notifying the mobile terminal of a state of the security device.

3. The control system according to claim 2, wherein
the security device is an electric lock, and
the first notification function is a function of notifying the mobile terminal of an unlocked state of the electric lock.

4. The control system according to claim 3, wherein
the electric lock is a crescent lock for unlocking and locking a window.

5. The control system according to claim 2, wherein
the security device is an open/close sensor of a window or a door, and
the first notification function is a function of notifying the mobile terminal of an open state detected by the open/close sensor.

6. The control system according to claim 2, wherein
the security device is a human detection sensor, and
the first notification function is a function of notifying the mobile terminal that a person is detected by the human detection sensor.

7. The control system according to claim 1, wherein
the control unit is configured to perform, using the communication unit, a second notification function as the predetermined control, the second notification function being a function of notifying the mobile terminal that the first notification function is disabled.

8. The control system according to claim 7, wherein
the setting unit is capable of setting the second notification to an enabled state or a disabled state.

9. The control system according to claim 3, wherein
the control unit is configured to perform, as the predetermined control, a first control of switching the electric lock from an unlocked state to a locked state.

10. The control system according to claim 9, wherein
the control unit is configured to perform, in addition to the first control, a second control of notifying that the electric lock is switched from the unlocked state to the locked state.

11. The control system according to claim 1, wherein
the control unit is configured to perform, as the predetermined control, a control of causing the setting unit to set the first notification function to the enabled state.

12. The control system according to claim 1, wherein
the setting unit is configured to further set the first notification function to the disabled state when the first notification function is set to the enabled state and the mobile terminal is determined to have moved from the outside of the predetermined area to the inside of the predetermined area.

13. The control system according to claim 1, wherein
the communication unit is configured to receive current position information of the mobile terminal from the mobile terminal, and
the control unit is configured to determine whether the mobile terminal has moved from the inside of the predetermined area to the outside of the predetermined area, based on the current position information received by the communication unit.

14. The control system according to claim 13, wherein
the current position information indicates whether a current position is inside the predetermined area, and does not indicate coordinates of the current position.

15. The control system according to claim 1, wherein
the device is installed in a building,
the predetermined area is an area in which a radio communication device installed in the building is capable of radio communication,
the communication unit is configured to receive, from the mobile terminal, communication connection information indicating a state of communication connection between the mobile terminal and the radio communication device, and
the control unit is configured to determine whether the mobile terminal has moved from the inside of the predetermined area to the outside of the predetermined area based on the communication connection information received by the communication unit.

16. A non-transitory computer-readable recording medium having recorded thereon a program that causes a computer to execute:
setting, to an enabled state or a disabled state, a first notification function of notifying a mobile terminal of a state of a device by performing communication; and
performing a predetermined control when the first notification function is set to the disabled state and the mobile terminal is determined to have moved from inside of the predetermined area to outside of the predetermined area.
